(19) United States
(12) Patent Application Publication
(10) Pub. No.: US 2012/0172132 A1
(43) Pub. Date: Jul. 5, 2012

(54) Content Synchronization

(75) Inventors: Justin Molyneaux, San Francisco, CA (US); Pete Banks, San Francisco, CA (US)

(73) Assignee: VIACOM INTERNATIONAL INC., NEW YORK, NY (US)

(21) Appl. No.: 12/985,053

(22) Filed: Jan. 5, 2011

(51) Int. Cl. G06F 17/00

(52) U.S. Cl. 463/42; 463/43

(57) ABSTRACT

Described are methods, systems, and computer program products for synchronizing game content access to the broadcast of particular television content. A game, wherein a portion of the game is locked and inaccessible to a player of the game, is provided via a gaming network comprising one of an Internet network, a cable television network, or an interactive television network. An identifier is provided to a television program for broadcast, which is then viewed by the player. The player inputs the identifier, the identifier is validated, and, if the identifier is valid, the locked portion of the game is unlocked and made accessible to the player.

### FIELD OF THE INVENTION

The present invention relates to unlocking content in a game, and, more specifically, to synchronizing access to game content to the broadcast of particular television content.

### BACKGROUND

Interactive entertainment, or more colloquially, “video games,” is big business. But as more and more games are offered in stores or online, it becomes more and more difficult for a particular game to compete for a consumer's dollar. To incentivize gamers to purchase a product at a particular store, some game developers provide stores with store-specific codes, with the codes assigned to each store allowing the user to download additional in-game items or abilities (specific to where the user purchased the game). For example, the game developer may offer one in-game outfit for an avatar to users that purchase their copy of the game at GameStop, while offering a different in-game outfit to users that purchase their copy of the game at Best Buy. These codes are usable throughout the lifespan of the game, and may be input long after the game has been purchased, or even by another user if the game is bought second-hand.

Another medium that competes for consumers' time is television. Currently many users utilize time-shifting devices like digital video recorders (DVRs), or the Internet, to watch television shows rather than watching the broadcast of the television show at the time it airs. This can result in consumers watching a television program days, or even weeks after it airs, with many DVRs providing the additional functionality of skipping commercials during playback of the program.

### SUMMARY OF THE INVENTION

The current invention provides an incentive for a user to tune into a particular television program at the time it airs. Beneficially, this increases viewership of the television program, and correspondingly advertisement revenue, while simultaneously rewarding loyal viewers.

In one aspect, the invention relates to a method, executed on a game content management server, for unlocking content in a game. The method includes providing the game via a gaming network comprising one of an Internet network, a cable television network, or an interactive television network, wherein a portion of the game is locked and inaccessible to a player; providing an identifier to a television program for broadcast; receiving the identifier from the player via the gaming network; validating the identifier; and unlocking the portion of the game if the identifier is valid and making the portion of the game accessible to the player. Advantageously, in another aspect, the invention is a computer program product, tangibly embodied in a non-transitory computer-readable storage medium, that has instructions operable to cause a data processing apparatus—such as a computer or, specifically, a content management server—to perform the method described above.

In some embodiments, unlocking the content includes determining if a timer associated with a code provided to the user has expired and unlocking the portion of the game only if the timer has not expired. In some versions of these, the identifier is generated based on the timer.

In some embodiments, the portion of the game that is unlocked is based on the identifier, so that providing two different, but equally valid identifiers unlocks different portions of the game.

In some embodiments, the ability to unlock the game content is synchronized to the identifier being broadcast on the television program, that is, unlocking the portion of the game can occur only after the identifier is broadcast on the television program.

In yet another aspect, the invention relates to a system for unlocking content in a game, the system including a game content management server, a transceiver, a receiver, and a validation engine. The game content management server is configured to provide the game via a gaming network comprising one of an Internet network, a cable television network, or an interactive television network, wherein a portion of the game is locked and inaccessible to a player of the game. The transceiver is configured to transmit an identifier to a television program or television station for broadcast, e.g., the identifier is sent via email or using an agreed-upon protocol. The receiver is configured to receive the identifier from the player via the gaming network. The validation engine is in signal communication with the game content management server and is configured to determine if the identifier is valid. In addition, the game content management unlocks the portion of the game if the validation engine determines the identifier is valid and makes the portion of the game accessible to the player. In some embodiments, the game content management server unlocks the portion of the game only if a timer has not expired.

In another aspect, the invention relates to a method, executed on a game content management server, for unlocking access to a portion of a game provided over an Internet network; and in another aspect, the invention relates to a computer program product, tangibly embodied in a non-transitory computer-readable storage medium, including instructions operable to cause a data processing apparatus to perform the method. The method includes providing a first portion of the game over the Internet network; transmitting an identifier to a television program or interactive television program for broadcast; receiving the identifier from a player; and unlocking access to a second portion of the game based on the identifier.

In some embodiments, the access that is unlocked is Internet access to the second portion of the game. In some of these embodiments, the method further includes preventing Internet access to the second portion of the game before transmitting the identifier. In some of these embodiments, unlocking includes determining if a timer has expired; and unlocking Internet access to the second portion of the game if the timer has not expired. In other embodiments, the unlocking step includes validating the identifier after receiving it; and unlocking Internet access to the second portion of the game if the identifier is valid. In yet other embodiments, different identifiers unlock access to different second portions of the game.

In another aspect, the invention relates to a method for providing a game comprising an additional locked portion of the game; and in another aspect, the invention relates to a computer program product, tangibly embodied in a non-transitory computer-readable storage medium, including instructions operable to cause a data processing apparatus to perform the method. The method includes providing a first portion of the game on a web page, the first version not including an additional locked portion of the game; determining if a predetermined timer associated with a television program had elapsed; refreshing the web page if the predetermined timer has elapsed; and replacing the first version of the game with a second version of the game that includes the additional locked portion, wherein the additional portion is unlockable only if a player provides an unlock identifier.

In another aspect, the invention relates to a system for unlocking access to a portion of a game provided over an Internet network, the system including a transceiver, a receiver, and a game content management server. The transceiver is configured to transmit an identifier via a television program or interactive television program. The receiver is configured to receive the identifier from a player. The game content management server is configured to provide a first portion of the game over the Internet network and unlock access to a second portion of the game based on the identifier. In some embodiments, the game content management server unlocks access to the second portion of the game if a timer has not expired.

In yet another aspect, the invention relates to a system for providing a game comprising an additional locked portion, the system including a web server and an unlock module. The web server is configured to provide a web page comprising a first version of the game that does not include the additional locked portion of the game; determine if a predetermined timer associated with a television program has elapsed; refresh the web page if the predetermined timer has elapsed; and replace the first version of the game with a second version of the game that includes the additional locked portion. The unlock module is configured to receive and validate an unlock identifier; and unlock the additional locked portion of the game.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is an exemplary block diagram illustrating a system for unlocking content in a game;

FIG. 2 is a flowchart depicting an exemplary method for unlocking content in a game;

FIG. 3 is a flowchart depicting an exemplary method for unlocking access to a portion of a game provided over an Internet network;

FIG. 4 is a flowchart depicting an exemplary method for providing a game including an additional locked portion;

FIGS. 5A and 5B are exemplary screenshots depicting a locked gaming experience;

FIG. 5C is an exemplary screenshot depicting an unlocked gaming experience;

FIG. 5D is an exemplary screenshot depicting an error message resulting from the input of an invalid or expired identifier; and

FIG. 5E is an example of an awards page showing awards players can unlock by playing either the locked game content (after being unlocked) or the initially-unlocked game content.

### DETAILED DESCRIPTION

With all of the content options available to users, there is a need for innovative ways to pique and sustain the interest of a player of online games and for cross-selling or promoting a brand across various types of media. Accordingly, the present invention provides a way to merge the online gaming community with the television watching community. To achieve this, in one embodiment, the present invention provides a system in which a television program can be promoted to an online gamer by broadcasting unique identifiers during the television program which allow the online gamer access to otherwise-locked features of a game. This increases traffic to the TV program—because gamers want the unlock codes—and, correspondingly, to the online game once the codes have been obtained.

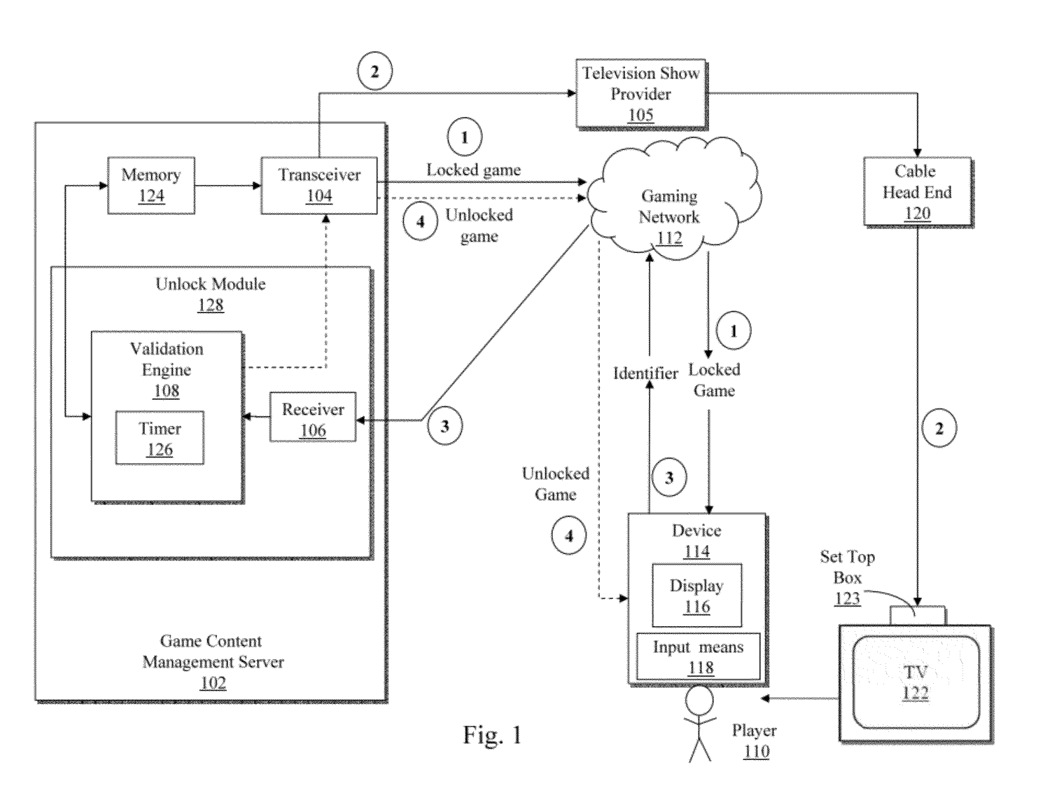

FIG. 1 is an exemplary block diagram illustrating a system for unlocking content in a game. The system includes a game content management server 102, transceiver 104 for sending the game codes to the television program provider 105, a receiver 106 for receiving game codes from players, and validation engine 108 for verifying that an input code is correct. The game content management server 102 can be a server computer—that is, a physical device—or can be software executing on such a computer along with other programs. The game content management server 102 provides games to players, e.g., player 110, via a gaming network 112, as indicated by the steps labeled (1). The gaming network 112 may comprise, for example, the Internet, a cable television network, or an interactive television network, or some combination of these.

In the beginning, the game provided to the player 110 is locked. That is, the player is unable to access certain portions of the game, certain levels, certain characters, and the like. The game is received (and played) on a device 114 in communication with the gaming network 112. The device 114 may be, for example, a laptop or desktop computer, a portable gaming device, a game console connected to a television, a personal digital assistant (PDA), a cellular telephone or combination of devices that can physically or wirelessly connect to the gaming network 112. Devices 114 typically include or are connected to a display 116 and an input means 118 through which the player 110 can play the game. The input means 118 can be, for example, a physical or virtual keyboard, a mouse, a joystick, a gamepad, a controller, a microphone, or any combination thereof. In some embodiments, the game is run in a web browser operating on the device 114, and the page that is loaded in the web browser is provided by the content management server 102. In those embodiments, the page loaded in the browser contains logic to communicate with the game management server, e.g., transmit the identifiers to the content management server using an HTTP form, or Javacript and XML, e.g., AJAX, commands, or the like, and has logic to process instructions received from the content management server 102, e.g., instructions from the content management server to unlock currently-locked portions of the game on the device 114.

The transceiver 104 is configured to transmit an identifier (unlock code) to be displayed as part of the show, indicated by the steps labeled (2). In some embodiments, the transceiver 104 may be a part of the game content management server 102. In other embodiments, the transceiver 104 may be separate from, but in communication with, the game content management server 102. In any of these embodiments, the transceiver 104 may be an Ethernet port on the game content management server 102, or can be a satellite or cable transceiver on the content management server 102 or in communication with the content management server 102. Typically the transceiver 104 sends the identifier to the television show provider 105, who then inserts the identifier into the program being broadcast using known techniques, e.g., video overlay. In some embodiments, this is accomplished by sending an email containing the identifier to the television show provider, who then inserts the identifier in the television program during broadcast using known techniques. Alternatively, the identifier can be transmitted to and inserted by an advertising content provider. The show is then transmitted to a cable or other service provider which then broadcasts the shows to consumers' televisions 122 or set top boxes 123 via, e.g., a cable head end 120 or similar device. Alternatively the transceiver 104 can transmit the identifier to directly the cable television head end 122, the cable or satellite television network, directly to consumers' set-top boxes, digital video recorders (DVR), or to any combination thereof, and the identifier can be inserted using know techniques, e.g., a video overlay or audio injection. The identifier is then “broadcast”—visually, aurally, or both—during a television show or during advertisements broadcast during the show.

The identifier is typically a series of alphanumeric characters, and can be randomly generated at the time of transmission, can be a message that is encrypted using known cipher techniques, e.g., AES256, or can be a predetermined set of alphanumeric characters that are stored in a lookup table in a database (not shown) in communication with the game content management server 102. Regardless of means of generation, the identifier is retained for use during validation by the validation engine 108.

The identifier is associated with a portion of the game that is locked and inaccessible to the player 110. In one embodiment, the locked portion of the game may include an advanced level or stage of the game. Alternatively or additionally, the locked portion may include one or more new features, commands, abilities usable by the player 110, or characters in the game. Alternatively or additionally, the locked portion may include a new game. In another embodiment, a number of identifiers may be associated with a locked portion of the game, such that the player must have all identifiers to unlock the particular portion of the game. Or, the game can include several locked portions, and each identifier unlocks only a specific portion. For example, a first identifier designates an unlocked version of the game that includes a first group of content, e.g., additional characters the player 110 can use, while a second identifier corresponds to an unlocked version of the game that includes a second group of content, e.g., additional levels the player 110 can play.

The identifier is broadcast during a television program with the intent that the player 110 will watch and/or listen to the television program at the time of broadcast, obtain the identifier, and utilize the identifier to access the locked portion of the game. To do so, the player 110 typically enters the identifier via the input means 118 of device 114, which then transmits the identifier to the validation engine 108, indicated by the steps labeled (3). In one embodiment, identifier is transmitted by the player 110 to the validation engine 108 via the gaming network 112, but this is not a requirement. The identifier can be transmitted via another network as well, e.g., over a cellular network or over the Internet (when the Internet is not part of the gaming network 112). The identifier is subsequently received by receiver 106, which is in communication with the validation engine 108. The receiver 106 may be an Ethernet port or similar data receiving device, and in some embodiments is the port or device as the transceiver 104.

After receiving the identifier, the validation engine 108 validates it to ensure the identifier is correct. Using the examples above, the identifier can be validated by comparing it against a lookup table of valid codes that are stored in a database, by decrypting the code to retrieve the encoded message and comparing the message against what was transmitted, or the validation engine 108 may validate the identifier by comparing it against a list of known identifiers stored in memory 124.

If the validation engine determines that the identifier is valid (e.g., the comparison by the validation engine 108 produces a match), the game content management server 102 unlocks the inaccessible portion of the game by sending a command to the player's device 114 to unlock the locked portion, thereby making the portion accessible to the player 110. Alternatively, in one embodiment, the content management server 102 directs the player to a specific address on the gaming network 112 (e.g., Internet address) or on the content management server (a page or file on the server) where the player 110 can download the unlocked portion of the game or a different version of the game with the portion unlocked.

In some embodiments, the identifier can unlock multiple portions of the game, e.g., all previously-locked portions. This enables players 110 that miss the first part of the broadcast to “catch up” and unlock portions of the game that were associated with codes that the player missed by being late. Alternatively, in some embodiments, the identifiers build on each other, such that the player can only unlock a later level by having already provided a previous unlock code. This encourages players 110 to watch the entire broadcast of the show and collect all unlock codes.

In one embodiment, the validation engine 108 determines that the code is valid (and thus the game content management server 102 only unlocks the portion of the game) only if a timer 126 has not expired. In these embodiments, the portion of the game may only be unlocked for a predetermined, limited amount of time after the identifier is received by receiver 106 or broadcast during the television program. Additionally or alternatively, the game content management server 102 unlocks the portion of the game only after the identifier is broadcast on the television program, such that the identifier cannot be used before the transmission, even if it is known to the user somehow before its broadcast. Additionally or alternatively, the unlocking is synchronized to the identifier being broadcast on the television program. All of these encourage the player 110 to tune into to the broadcast at the time of the broadcast, rather than record the show and watch it later, or get the identifier from somewhere else at a later time.

In some embodiments, the identifier is generated based on the state of the timer 126. For example, an identifier is generated only after timer 126 is activated but not yet expired. In still another embodiment, unlocking the locked portion of the game (block 260) is synchronized to the identifier being broadcast on the television program. For example, the game content management server 102 delays unlocking some or all of the locked portions of the game until the time at which the identifier is broadcast on the television program, irrespective of time zone of the broadcast. Alternatively, the unlocking occurs at the time the identifier is broadcast on the television program in a particular time zone (e.g., the time zone in which player 110 is in). In still yet another embodiment, unlocking some or all of the locked portion of the game (block 260) can occur only after the identifier is broadcast on the television program. Alternatively or additionally, the unlocking can only occur after the identifier is broadcast on the television program in a particular time zone (e.g., the time zone in which player 110 is in).

Regarding the locked portion of the game, in some embodiments, the game content management server 102 is a web server configured to provide a web page that has a link to the first version of the game that does not include the locked portion of the game. Upon determining that a predetermined timer 126 associated with a television program has elapsed—regardless of input by the player 110—the web server 102 refreshes the web page and replaces the first version of the game with a second version of the game that includes the locked portion of the game. Then, subsequent downloads of the game include the locked content. Additionally or alternatively, new content or a new web page may be uploaded to the game content management server 102 that includes one or more Internet addresses or URLs where the second version of the game can be accessed by player 110. The new content can be stored in memory 124 or from any other suitable storage system.

In some implementations, the game content management server 102 provides a web page that includes the full game, i.e., a game with both locked and unlocked portions. After the user has received the identifier and submitted it via device 114, and the validation engine 108 has indicated the identifier is a valid unlock code (using technique and variations described herein), the content management server 102 directs the user's device 114 to unlock the locked portion of the games.

Although depicted in FIG. 1 as being part of the content management server 102, in some embodiments, the validation engine 108 is separate from, but in communication with, the game content management server 102. Alternatively, the validation engine may be, or is part of, an unlock module 128 that is configured to receive and validate an unlock identifier and unlock the locked portion of the game.

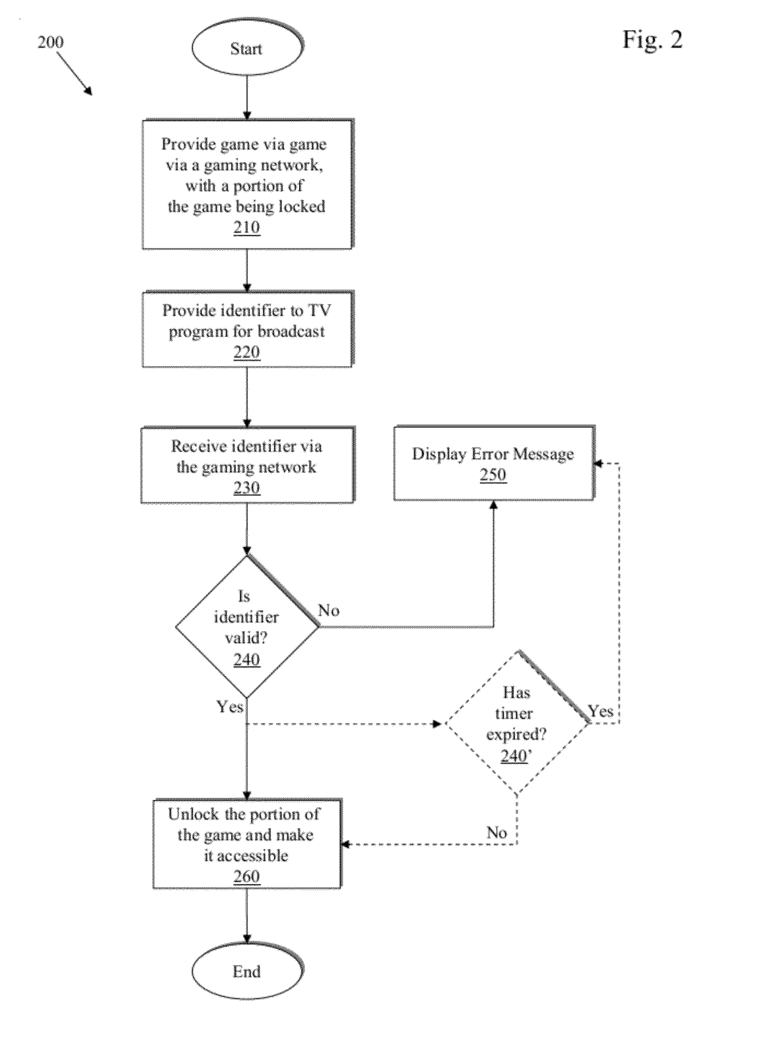

FIG. 2 is a flowchart depicting an exemplary method 200 for unlocking content in a game. With reference to FIG. 1, the method 200 includes the game content management server 102 providing the game (block 210) via the gaming network 112, wherein a portion of the game is locked and inaccessible to a player 110 of the game. The game content management server 102 further provides an identifier to a television program for broadcast (block 220). The player 110, who obtains the identifier upon viewing the television program broadcast, then transmits the identifier over the gaming network 112 to receiver 106 (block 230). The receiver 106 is in communication with the validation engine 108, which determines whether or not the identifier is valid (block 240). If the received identifier is invalid, an error message is transmitted to and displayed on display 116 of the player's device 114 (block 250). If the received identifier is valid, the game content management server 102 unlocks the locked portion of the game on the player's device 114 and makes the unlocked content accessible to the player 110 (block 260).

In some embodiments, block 240 further comprises determining whether a timer 126 associated with the unlockable content has expired. If the timer 126 has expired, then an appropriate error message is transmitted and displayed to the player 110 (block 250) and the content remains locked. Embodiments incorporating a timer 126 are advantageous because the player 110 is incentivized to watch the program when, or soon after, the program aired. If the player 110 waits too long to watch the program, e.g., he has recorded the show and watches it two days later, the timer 126 has expired and the content is not accessible. Beneficially, the number of viewers that is likely to watch the program at the time it airs will increase. If timer 126 has not yet expired, some or all of the locked portion of the game is unlocked and made accessible to player 110 (block 260).

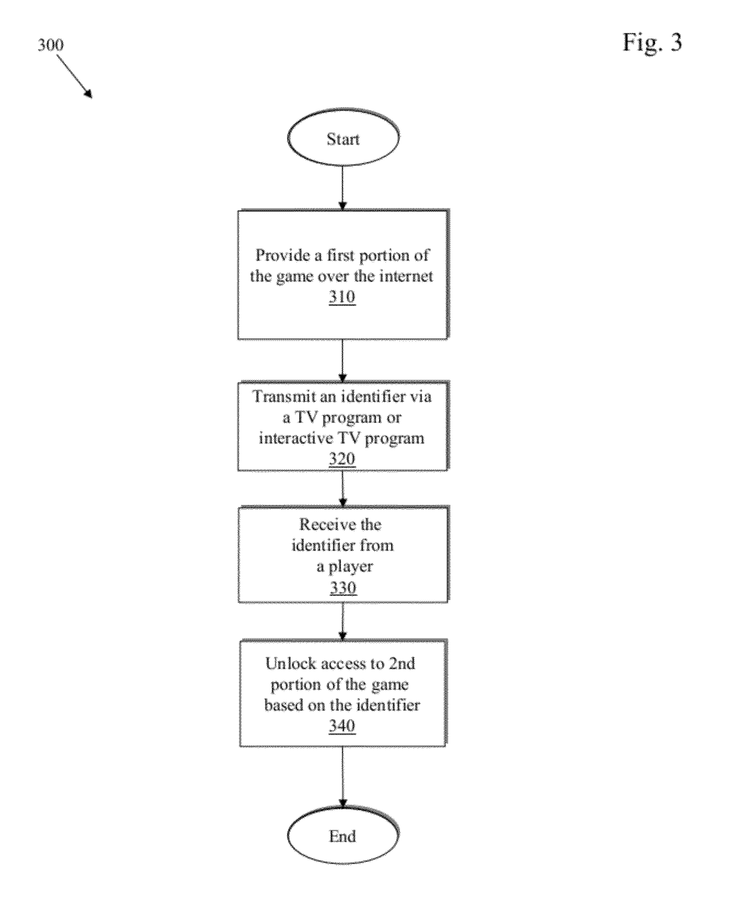

FIG. 3 is a flowchart depicting an exemplary method 300 for unlocking access to a portion of a game provided over an Internet network. Whereas FIG. 2 describes unlocking content in a game downloaded by the user, FIG. 3 describes unlocking access to a portion of a game that is stored on a web server, e.g., the game content management server 102. With reference to FIG. 1, the method 300 includes game content management server 102 providing a first portion of the game over the Internet network 112 (block 310), e.g., transmitting a web page that includes the game. The game content management server 102 further transmits an identifier via a television program or interactive television program (block 320), where it is viewed by a player 110 of the game. The identifier is then transmitted by the player 110 to a receiver 106 in the game content management server 102 (block 330). The game content management server 102 then unlocks access to a second portion of the game based on the received identifier (block 340), e.g., the access that is unlocked in block 340 is Internet access to the second portion of the game. In these embodiments, the game content management server 102 allows the player's IP address to access a web page that provides the new game. Or, providing a valid code causes the game content management server 102 to write a cookie to the player's device 114 and devices with the correct cookie are directed to a page with the unlocked content.

In some of these embodiments, the game content management server 102 prevents Internet access to the second portion of the game before transmitting the identifier via a television program or interactive television program in block 320. In some of these embodiments, block 340 further includes determining if timer 126 has expired and unlocking Internet access to the second portion of the game if the timer 126 has not expired. In other embodiments, block 340 further includes validating, by validation engine 108, the identifier after receiving it and unlocking access to the second portion of the game if the identifier is valid. In yet other embodiments, different identifiers unlock access to different second portions of the game.

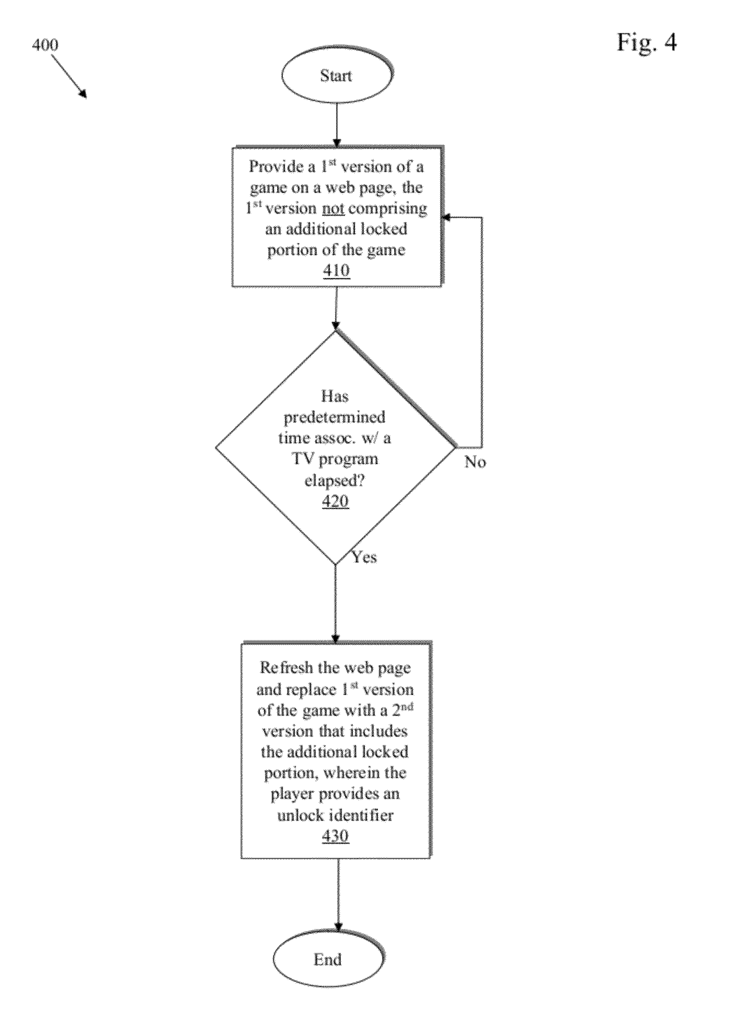

FIG. 4 is a flowchart depicting an exemplary method 400 for providing a game including an additional locked portion. With reference to FIG. 1, the method 400 includes a web server 102 providing a first version of a game on a web page, the first version not including an additional locked portion of the game (block 410). The web server 102 determines whether a predetermined timer 126 associated with a television program has elapsed (block 420). If the predetermined timer 126 has elapsed, the web server 102 refreshes the web page and replaces the first version of the game with a second version that includes the additional locked portion of the game (block 430). The additional locked portion is unlockable only if a player 110 provides an unlock identifier that is valid based on the logic described herein.

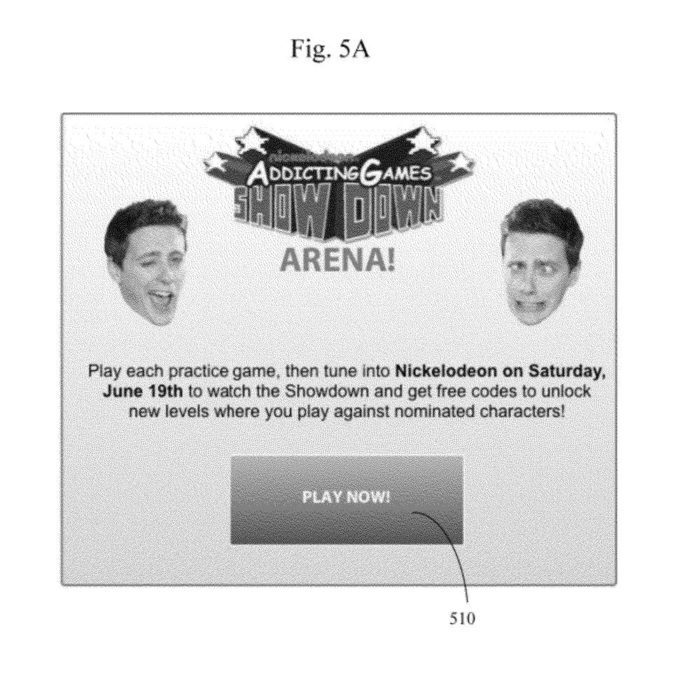

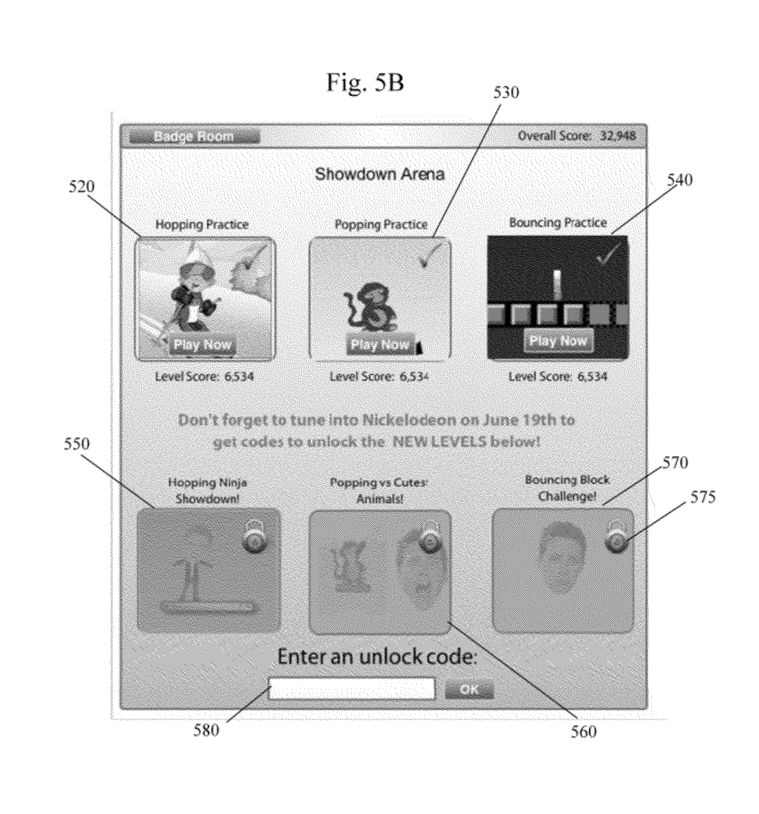

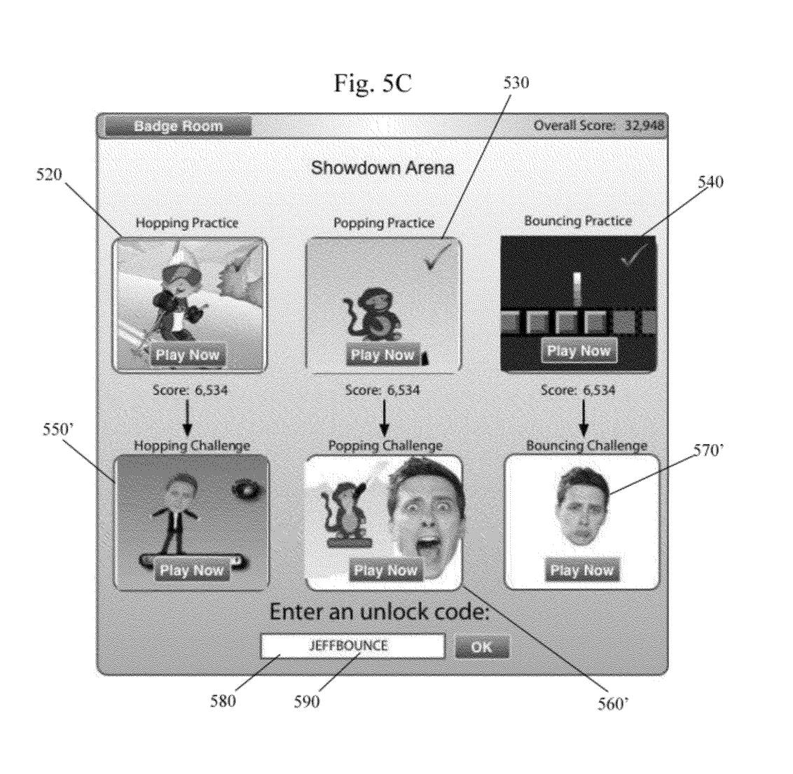

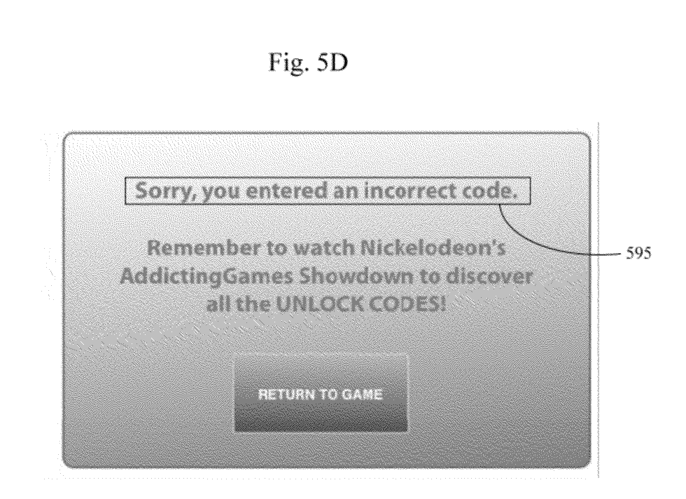

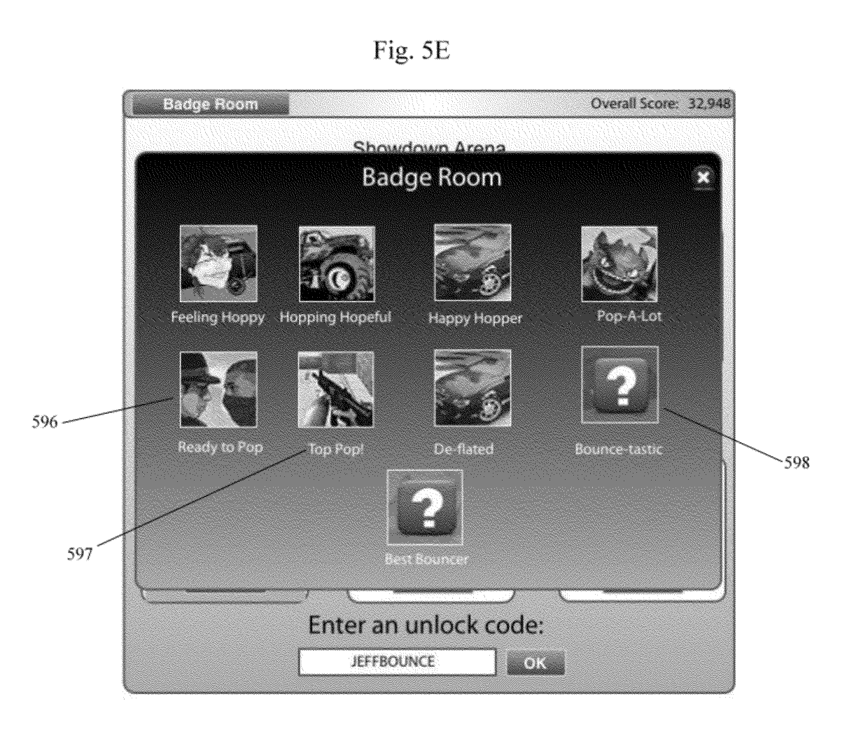

FIGS. 5A and 5B are exemplary screenshots depicting a locked gaming experience. In particular, FIG. 5A illustrates an initial display introducing the locked game to player 110 and notifying player 110 that an upcoming television broadcast will include one or more unlock identifiers to unlock various locked portions of the game. Upon clicking the “Play Now” button 510, player 110 is directed to the main game scene depicted in FIG. 5B.

The display in FIG. 5B presents three unlocked sub-games 520, 530, and 540 which are immediately accessible by player 110. FIG. 5B also presents three additional sub-games 550, 560, and 570, corresponding to advanced levels of sub-games 520, 530, and 540 respectively, which remain locked and inaccessible. Player 110 may enter one or more unlock identifiers via input area 580 to gain access to the various locked sub-games 550, 560, and 570. The games that are locked are typically displayed as greyed out and with a lock icon 575. In this embodiment, the player is expected to practice the game mechanics of the locked games 550, 560, and 570 by playing the unlocked games 520, 530, and 540. Once the show is aired, the identifier can be provided and the player can play the currently-locked game and, hopefully, achieve a high score having already practiced using the currently-unlocked games.

FIG. 5C is an exemplary screenshot of an unlocked gaming experience. In particular, once player 110 enters valid and/or unexpired unlock identifiers 590 via input area 580, the formerly locked sub-games are made available to player 110 as unlocked sub-games 550′, 560′, and 570′. In the embodiment showin in FIG. 5C, the player 110 has already unlocked the Hopping Challenge level 550′ and the Popping Challenge 560′, with the identifier “JEFFBOUNCE” unlocking the Bouncing Challenge 570′. Were player 110 to have entered an invalid and/or expired unlock code, an error message 595 such as that depicted in FIG. 5D is instead presented to the player 110. While playing the unlocked games, the player can receive special items or awards by completing in-game tasks or achieving a certain score, with these awards or items being shared on the game website or on social networking sites such as Facebook, MySpace, and the like. In some implementations, these awards are only available to users that have played the unlocked games, thus incentivizing players to watch the show, unlock the new levels, and play the games. Examples of the awards available to the user are shown in FIG. 5E. As shown in FIG. 5E, the player has achieved “Ready to Pop” 596 and “Top Pop!,” 597 but has not performed the necessary actions to achieve “Bounce-tastic” 598, as indicated by a question mark in the award window.

The above-described techniques can be implemented in digital electronic circuitry, or in computer hardware, firmware, software, or in combinations of them. The implementation can be as a computer program product, i.e., a computer program tangibly embodied, e.g., in a non-transitory, machine-readable storage device for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, sub-routine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and an apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or is operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

In some embodiments, execution of methods embodied as software limits the game content management server to a particular purpose, e.g., providing the game, transmitting codes, validating received codes, and unlocking the locked content. In these scenarios, the game content management server 102, combined with the software, in effect, becomes a particular machine while the software is executing. In some embodiments, though other tasks may be performed while the software is running, execution of the software still limits the game content management server 102 and may negatively impact performance of the other tasks. While the software is executing, the game content management server 102 receives codes for validation, validates the code, and unlocks the user's software, thereby controlling the player's access to the locked game content. This effectively transforms the codes input by the players into additional game content.

To provide for interaction with a user or administrator, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A method, executed on a game content management server, for unlocking content in a game, the method comprising:
providing the game via a gaming network, the gaming network comprising one of an Internet network, a cable television network, or an interactive television network, wherein a portion of the game is locked and inaccessible to a player of the game;
providing, an identifier to a television program provider for inclusion during a television program broadcast;
receiving the identifier from the player via the gaming network;
validating the identifier; and
unlocking the portion of the game if the identifier is valid and making the portion of the game accessible to the player.

2. The method of claim 1, wherein unlocking comprises:
determining if a timer has expired; and
unlocking the portion of the game only if the timer has not expired.

3. The method of claim 1, further comprising generating the identifier based on the timer.

4. The method of claim 1, wherein the portion of the game that is unlocked is based on the identifier.

5. The method of claim 1, wherein the identifier unlocks multiple locked portions of the game associated with other identifiers.

6. The method of claim 1, wherein unlocking the portion of the game is synchronized to the identifier being broadcast on the television program.

7. The method of claim 1, wherein unlocking the portion of the game can occur only after the identifier is broadcast on the television program.

8. The method of claim 1, wherein providing the identifier to the television program for broadcast comprises emailing the identifier to a television show provider before the broadcast for insertion into the television show.

9. A method, executed on a game content management server, for unlocking access to a portion of a game provided over an Internet network, the method comprising:
providing a first portion of the game over the Internet network;
transmitting an identifier via a television program or interactive television program;
receiving the identifier from a player; and
unlocking access to a second portion of the game based on the identifier.

10. The method of claim 9 wherein the access that is unlocked is Internet access to the second portion of the game.

11. The method of claim 10, further comprising:
preventing Internet access to the second portion of the game before transmitting the identifier.

12. The method of claim 11, wherein unlocking comprises:
determining if a timer has expired; and
unlocking Internet access to the second portion of the game if the timer has not expired.

13. The method of claim 9, wherein the unlocking step comprises:
validating the identifier after receiving it; and
unlocking access to the second portion of the game if the identifier is valid.

14. The method of claim 9, wherein different identifiers unlock access to different second portions of the game.

15. A method, executed on a server, comprising:
providing a first version of a game on a web page, the first version not comprising an additional locked portion of the game;
determining if a predetermined timer associated with a television program had elapsed;
refreshing the web page if the predetermined timer has elapsed; and
replacing the first version of the game with a second version of the game that includes the additional locked portion,
wherein the additional portion is unlockable only if a player provides an unlock identifier.

16. A computer program product, tangibly embodied in a non-transitory computer-readable storage medium, for unlocking content in a game, the computer program product comprising instructions operable to cause a data processing apparatus to:
provide the game via a gaming network comprising one of an Internet network, a cable television network, or an interactive television network, wherein a portion of the game is locked and inaccessible to a player of the game;
provide an identifier to a television program for broadcast;
receive the identifier from the player via the gaming network;
validate the identifier; and
unlock the portion of the game if the identifier is valid and make the portion of the game accessible to the player.

17. A computer program product, tangibly embodied in a non-transitory computer-readable storage medium, for unlocking access to a portion of a game provided over an Internet network, the computer program product comprising instructions operable to cause a data processing apparatus to:
provide a first portion of the game over the Internet network;
transmit an identifier to a television program or interactive television program for broadcast;
receive the identifier from a player; and
unlock access to a second portion of the game based on the identifier.

18. A computer program product, tangibly embodied in a non-transitory computer-readable storage medium, for providing a game comprising an additional locked portion of the game, the computer program product comprising instructions operable to cause a data processing apparatus to:
provide a first version of the game on a web page, the first version not comprising the additional locked portion;
determine if a predetermined timer associated with a television program had elapsed;
refresh the web page if the predetermined timer has elapsed; and
replace the first version of the game with a second version of the game that includes the additional locked portion, wherein the additional locked portion is unlockable only if a player provides an unlock identifier.

19. A system for unlocking content in a game, the system comprising:
a game content management server to provide the game via a gaming network comprising one of an Internet network, a cable television network, or an interactive television network, wherein a portion of the game is locked and inaccessible to a player of the game;
a transceiver to transmit an identifier to a television program show provider for inclusion of the identifier in a television program broadcast;
a receiver to receive the identifier from the player via the gaming network; and
a validation engine in signal communication with the game content management server that determines if the identifier is valid;
wherein the game content management server:
(i) unlocks the portion of the game if the validation engine determines the identifier is valid; and
(ii) makes the portion of the game accessible to the player.

20. The system of claim 19, wherein the game content management server unlocks the portion of the game only if a timer has not expired.

21. A system for unlocking access to a portion of a game provided over an Internet network, the system comprising:
a transceiver to transmit an identifier to a television program show provider or interactive television program for inclusion of the identifier in a program broadcast;
a receiver to receive the identifier from a player; and
a game content management server to:
provide a first portion of the game over the Internet network; and
unlock access to a second portion of the game based on the identifier.

22. The system of claim 21, wherein the game content management server unlocks access to the second portion of the game if a timer has not expired.

23. A system for providing a game comprising an additional locked portion, the system comprising:
a web server configured to:
provide a web page comprising a first version of the game that does not include the additional locked portion of the game;
determine if a predetermined timer associated with a television program has elapsed;
refresh the web page if the predetermined timer has elapsed; and
replace the first version of the game with a second version of the game that includes the additional locked portion; and
an unlock module configured to:
receive an unlock identifier;
validate the unlock identifier; and
unlock the additional locked portion of the game.
